(19) United States
(12) Patent Application Publication
(10) Pub. No.: US 2016/0137772 A1
(43) Pub. Date: May 19, 2016

(54) HYDROPHOBIC INORGANIC PARTICLES, RESIN COMPOSITION FOR HEAT DISSIPATION MEMBER, AND ELECTRONIC COMPONENT DEVICE

(71) Applicant: SUMITOMO BAKELITE CO., LTD., Tokyo (JP)

(72) Inventor: Shigeyuki MAEDA, Tokyo (JP)

(73) Assignee: SUMITOMO BAKELITE CO., LTD., Tokyo (JP)

(21) Appl. No.: 14/894,604

(22) PCT Filed: May 1, 2014
(86) PCT No.: PCT/JP2014/062055

§ 371 Date: Nov. 30, 2015

(30) Foreign Application Priority Data
May 30, 2013 (JP) 2013-114552

(51) Int. Cl. C08G 8/28; C07F 5/06; C09K 5/08

(52) U.S. Cl. CPC C08G 8/28; C09K 5/08; C07F 5/069

(57) ABSTRACT

Disclosed are hydrophobic inorganic particles obtained by surface-modifying inorganic particles with an organic compound, in which with respect to the hydrophobic inorganic particles subjected to a washing step, a weight reduction rate is calculated under measurement conditions described below, and the number of molecules of the organic compound per 1 nm² of inorganic particles before a surface treatment, which is calculated by a calculation expression described below, is 1.7 to 20.

(Calculation Expression)

If the number of molecules of the organic compound per 1 nm² of inorganic particles is N,
a weight reduction rate (%) is R,
a specific surface area of inorganic particles is S (m²/g), and
a molecular weight of organic compound is W (g),

N=(6.02×10²³×10⁻¹⁸×R×1)/(W×S×(100−R))

### TECHNICAL FIELD

The present invention relates to hydrophobic inorganic particles, a resin composition for heat dissipation member, and an electronic component device.

### BACKGROUND ART

In the related art, in an electronic apparatus, various types of members for heat dissipation (hereinafter, also referred to as “heat dissipation member”) such as a sheet or an encapsulating material have been used. As the members for the heat dissipation, for example, products obtained by molding a resin composition including an inorganic filling material and a resin. In the resin composition, in view of moldability or the like, high fluidity is required.

Also, a method of performing a surface treatment on the particle surface of the inorganic filling material with a silane coupling agent has been proposed (Patent Document 1).

### RELATED DOCUMENT

### Patent Document

[Patent Document 1] Japanese Laid-open Patent Publication No. 2009-007405

### SUMMARY OF THE INVENTION

As described above, the resin composition used in the members for heat dissipation requires high fluidity, and thus the fluidity of the resin composition is increased by treating a surface of an inorganic filling material.

However, until now, the fluidity of the resin composition has been able to be increased, but the thermal conduction properties of the resin composition have not been able to be enhanced.

According to the invention,

there are provided hydrophobic inorganic particles obtained by surface-modifying inorganic particles with an organic compound,

in which, with respect to the hydrophobic inorganic particles subjected to a washing step described below, a weight reduction rate is calculated under measurement conditions described below, and the number of molecules of the organic compound per 1 nm² of inorganic particles before a surface treatment, which is calculated by a calculation expression described below, is 1.7 to 20.0.

(Washing Step)

200 parts by mass of ethanol is added to 1 part by mass of the hydrophobic inorganic particles, ultrasonic washing is performed for 10 minutes, solid-liquid separation is performed, and drying is performed.

(Measurement Conditions)
Measurement device: Thermogravimetry-Differential Thermal Analysis (TG-DTA)
Environment: Atmospheric environment
Measurement temperature: Temperature increases from 30° C. to 500° C.
Temperature increasing speed: 10° C./min

(Calculation Expression)

If the number of molecules of the organic compound per 1 nm² of inorganic particles is N,

a weight reduction rate (%) is R,

a specific surface area of inorganic particles is S (m²/g), and

a molecular weight of organic compound is W (g),

N=(6.02×10²³×10⁻¹⁸×R)/(W×S×(100−R))

The resin composition using the hydrophobic inorganic particles has high fluidity and enhanced thermal conductivity and thus excellent fluidity and thermal conduction properties are compatible with each other.

Further, according to the invention, the resin composition for heat dissipation member described above including the hydrophobic inorganic particles and the resin can be provided.

In addition, according to the invention, the electronic component device including the resin composition for heat dissipation member described above can be provided.

According to the invention, hydrophobic inorganic particles in which excellent fluidity and excellent thermal conduction properties of a resin composition can be compatible with each other, and a resin composition including hydrophobic inorganic particles are provided.

### BRIEF DESCRIPTION OF THE DRAWINGS

The objects described above, other objects, characteristics, and advantages are further described in preferred embodiments described below and drawings accompanied thereby.

FIG. 1 is a diagram illustrating data by obtained by hydrophobic inorganic particles, an organic compound, and inorganic particles by FT-IR (diffuse reflection method).

FIG. 2 is a diagram illustrating data obtained by measuring hydrophobic inorganic particles by FT-IR (diffuse reflection method) at 30° C. to 700° C.

FIG. 3 is a diagram illustrating volume-based particle size distribution of inorganic particles.

### DESCRIPTION OF EMBODIMENTS

Hereinafter, embodiments of the invention are described with reference to the drawings. In addition, in all drawings, the same configurations are denoted by the same reference numerals, and the detailed descriptions will not be repeated, so as not to be repetitively described.

In addition, according to the embodiment, the “heat dissipation member” refers to a member used in a portion in which heat dissipation properties are required, in an electronic component device such as a semiconductor device or the like in which excellent heat releasability is required. As the portion, for example, an encapsulating material that encapsulates the electronic device that generates heat such as a semiconductor device, an adhesive agent that attaches a semiconductor package to a heat dissipation material such as a heat dissipation fin, or the like are included.

First, a summary of hydrophobic inorganic particles according to the embodiment is described. Particularly, unless otherwise described, the expression “to” refers to “equal to or greater than . . . and equal to or less than . . . ”

The hydrophobic inorganic particles are hydrophobic inorganic particles obtained by surface-modifying inorganic particles with an organic compound.

Here, hydrophobic inorganic particles and inorganic particles each mean a particle group.

With respect to the hydrophobic inorganic particles subjected to a washing step described below, a weight reduction rate is calculated under measurement conditions described below, and the number of molecules of the organic compound per 1 nm² of inorganic particles before a surface treatment, which is calculated by a calculation expression described below, becomes 1.7 to 20.0.

(Washing Step)

200 parts by mass of ethanol is added to 1 part by mass of the hydrophobic inorganic particles, ultrasonic washing is performed for 10 minutes, solid-liquid separation is performed, and drying is performed.

(Measurement Conditions)
Measurement device: Thermogravimetry-Differential Thermal Analysis (TG-DTA)
Environment: Atmospheric environment
Measurement temperature: Temperature increases from 30° C. to 500° C.
Temperature increasing speed: 10° C./min

(Calculation Expression)

If the number of molecules of the organic compound per 1 nm² of inorganic particles is N,

a weight reduction rate (%) is R,

a specific surface area of inorganic particles is S (m²/g), and

a molecular weight of organic compound is W (g),

N=(6.02×10²³×10⁻¹⁸×R)/(W×S×(100−R))

The resin composition using the hydrophobic inorganic particles has high fluidity and enhanced thermal conductivity, and thus excellent fluidity and thermal conduction properties are compatible with each other.

Subsequently, the hydrophobic inorganic particles are described in detail.

The hydrophobic inorganic particles are obtained by surface-modifying inorganic particles with an organic compound (organic modifier). If the inorganic particles are modified with the organic compound, hydrophobicity is increased.

The hydrophobic inorganic particles are composed of a particle group of surface-modified particles obtained by surface-modifying particle cores (product corresponding to particles which are not surface-modified) composed of an inorganic material with the organic compound.

The inorganic particles are preferably thermally conductive particles. The inorganic particles are a group of particle cores composed of an inorganic material, but the particle cores of the inorganic material are preferably composed of any one of the materials selected from the group consisting of silica (fused silica, crystalline silica), alumina, zinc oxide, silicon nitride, aluminum nitride, and boron nitride.

Among them, in view of increasing the fluidity and the thermal conduction properties of the resin composition, it is preferable that spherical alumina is used.

In order to use the inorganic particles as raw materials, the specific gravity of the hydrophobic inorganic particles is greater than that of hexane or water described below.

The organic compound has at least one functional group of a carboxyl group, an amino group, and a hydroxyl group, and is preferably chemically bonded to the surfaces of the particle cores composed of the inorganic material, through the functional group. The functional group easily reacts with hydroxyl groups or the like which are abundant on the particle core surface composed of the inorganic material, and the organic compound having such a functional group can be easily chemically bonded to the particle cores composed of the inorganic material.

In addition, it is preferable that the organic compound has a hydrophobic portion composed of five or more carbon chains. The organic compound preferably has 30 or less carbon atoms. In addition, if the organic compound is a phenol resin, it is preferable that a number average molecular weight is equal to or less than 2,000, and a hydroxyl group equivalent is equal to or greater than 70 and equal to or less than 250.

For example, as the organic compounds, one or more kinds selected from compounds included in Groups (i) to (v) below can be used:

(i) amine and carboxylic acid which are monobasic acid having 8 or more carbon atoms (in the case of carboxylic acid, carbons in the carboxyl group are excluded) and having a straight chain or a branched chain;

(ii) amine and carboxylic acid which are dibasic acid having 6 or more carbon atoms (in the case of carboxylic acid, carbons in the carboxyl group are excluded) and having a straight chain or a branched chain;

(iii) amine and carboxylic acid which are monobasic acid having a straight chain or a branched chain, including a carbon-carbon double bond;

(iv) amine and carboxylic acid which are monobasic acid or dibasic acid, having an aromatic ring;

(v) alcohol or phenol compound having 6 or more carbon atoms, where the compounds included in Groups (iii) and (iv) are not included in Group (i), and, the compounds included in Group (iv) are not included in Group (ii).

In addition, one kind of organic compounds may be chemically bonded to one particle core composed of an inorganic material or two or more kinds of organic compounds may be chemically bonded to each other.

If the hydrophobic inorganic particles surface-modified with the organic compound are included in the resin composition, though the reason is not clear, the flow resistance on the interface between the hydrophobic inorganic particles and the matrix resin decreases, and the fluidity of the resin composition can be further enhanced. Further, if the inorganic particles are surface-modified with the organic compound described above, the thermal resistance or the thermal loss on the interface between the hydrophobic inorganic particles and the matrix resin can be reduced. Therefore, excellent fluidity and thermal conduction properties can be compatible with each other.

For example, Group (i) includes CH₃—(CH₂)n-COOH (n is an integer in the range of 7 to 14) and CH₃—(CH₂)n-NH₂ (n is an integer in the range of 7 to 14). More specifically, Group (i) includes decanoic acid, lauric acid, myristic acid, palmitic acid, decylamine, undecylamine, and tridecylamine.

In addition, Group (ii) includes, for example, HOOC—(CH₂)n-COOH (n is an integer in the range of 6 to 12) and NH₂—(CH₂)n-NH₂ (n is an integer in the range of 6 to 12). As the HOOC—(CH₂)n-COOH (n is an integer in the range of 6 to 12), suberic acid and sebacic acid are included.

Further, Group (iii) includes unsaturated fatty acid having equal to or greater than 12 and equal to or less than 30 carbon atoms (carbons in the carboxyl group are excluded) and aliphatic amine having equal to or greater than 12 and equal to or less than 30 carbon atoms. Oleic acid and linoleic acid are included in the unsaturated fatty acid, and oleylamine is included in the aliphatic amine.

Group (iv) includes, for example, aromatic amines such as phthalic acid, hydroxybenzoic acid, aniline, toluidine, naphthylamine, and an aniline resin.

Group (v) includes, for example, phenols such as phenol, Cresol, and naphthol, a phenol resin, or products obtained by substituting a carboxyl group or an amino group of the compounds in Groups (i), (ii), and (iii) with a hydroxyl group. As the products obtained by substituting a carboxyl group or an amino group of the compounds in Groups (1), (ii), and (iii) with a hydroxyl group, CH₃—(CH₂)n-OH (n is an integer in the range of 7 to 14), OH—(CH₂)n-OH (n is an integer in the range of 6 to 12), oleyl alcohol, and linoleyl alcohol are included.

Here, the organic compound preferably does not include a well-known coupling agent in the related art. If a silanol group is included as in the silane coupling agent, interaction with the inorganic particles which is the feature of the invention may be small.

(Physical Properties of Hydrophobic Inorganic Particles)

The hydrophobic inorganic particles as described above have the following physical properties.

(Physical Properties 1)

200 parts by mass of ethanol is added to 1 part by mass of the hydrophobic inorganic particles, ultrasonic washing is performed for 10 minutes, solid-liquid separation is performed, and drying is performed (washing step). For the solid-liquid separation, a centrifugal separator is used.

Thereafter, when 0.1 g of the hydrophobic inorganic particles are dispersed in 40 g of the liquid mixture (25° C.) obtained by mixing hexane and water in a volume ratio of 1:1 (liquid mixture in the weight of 400 times of the weight of the hydrophobic inorganic particles), 50% by mass or greater of the hydrophobic inorganic particles are transformed to a phase in which hexane is included.

More specifically, it is determined whether the hydrophobic inorganic particles are transformed to a phase in which hexane is included in the following steps. 40 g of the liquid mixture obtained by mixing hexane and water in a volume ratio of 1:1 is introduced to a transparent container, and 0.1 g of the hydrophobic inorganic particles after the washing step described above is added. Thereafter, the container is shaken for 30 seconds, and the hydrophobic inorganic particles are dispersed in a transformed solvent using an ultrasonic washing device.

Thereafter, the container is stood still for 2 minutes.

Since hexane has a smaller specific gravity than water, a phase in which hexane is included is formed on the upper portion of the container, and a water phase in which hexane is not included is formed on the lower portion of the container. Thereafter, the phase in which hexane is included is extracted with a pipette or the like, so as to separate the phase in which hexane is included from the water phase.

In addition, the water phase may be extracted by using a separating funnel as a container.

Subsequently, the hydrophobic inorganic particles are extracted by drying the phase in which hexane is included, and the weight thereof is measured. Accordingly, the ratio of the hydrophobic inorganic particles transformed to the phase in which hexane is included can be recognized.

Generally, since the hydrophobic inorganic particles have a greater specific gravity than hexane and water, it is considered that the hydrophobic inorganic particles are precipitated in the lower portion of the container described above. However, according to the embodiment, since the hydrophobic inorganic particles are very hydrophobic and highly compatible with hexane, it is considered that the hydrophobic inorganic particles stay in the phase in which hexane is included.

Also, if the hydrophobic inorganic particles are used in the resin composition, though the reason is not clear, the flow resistance on the interface between the hydrophobic inorganic particles and the matrix resin decreases, and fluidity of the resin composition is further enhanced. In addition, if the hydrophobic inorganic particles are used, the thermal resistance or the thermal loss on the interface of the matrix resin can be reduced, and thus excellent fluidity and thermal conduction properties are compatible with each other.

Among them, after the washing step described above is performed, when 0.1 g of hydrophobic inorganic particles are dispersed in 40 g of the liquid mixture obtained by mixing hexane and water in a volume ratio of 1:1, it is preferable that 80% by mass or greater of the hydrophobic inorganic particles are transformed to the phase in which hexane is included, and it is more preferable that 85% by mass or greater of the hydrophobic inorganic particles are transformed. The upper limit is not particularly limited, but, for example, is 100% by mass.

It is supposed that, if the hydrophobic inorganic particles of which 80% by mass or greater are transformed to a phase in which hexane is included are manufactured, not only the number of the hydrophobic particles surface-modified with the organic compound is simply great, but also a surface-modified state of the organic compound is very satisfactory, compared with the hydrophobic inorganic particles of which about 50% by mass are transformed to the phase in which hexane is included.

This is understood from the number of molecules of the organic compound per 1 nm² of the inorganic particles calculated from a weight reduction rate described below. It is supposed that the hydrophobic inorganic particles of which 80% by mass or greater are transformed to the phase in which hexane is included allow the number of molecules of the organic compound per 1 nm² of the inorganic particles calculated from the weight reduction rate to be an ideal number.

It is considered that if the number of molecules of the organic compound per 1 nm² of the inorganic particles calculated from the weight reduction rate is large, the organic compound chemically bonded to the inorganic particles and another organic compound become in any kind of excessive states such as a multilayered structure, through a chemical bond such as a hydrogen bond, and thus hydrophilic groups are in a state of facing the outside.

In contrast, if the number of molecules of the organic compound per 1 nm² of the inorganic particles calculated from the weight reduction rate is ideal, the organic compound that surface-modifies the inorganic particles and another organic compound are chemically bonded to each other and do not become in any kind of excessive states such as a multilayered structure, but become in a state in which a hydrophobic portion of the organic compound chemically bonded to the particle core composed of the inorganic material faces the outside of the particle core composed of the inorganic material. Therefore, it can be understood that the surface modification state of the organic compound becomes a very satisfactory state.

It is considered that a modification state of the organic compound gives great influence on the fluidity and the thermal conduction properties of the resin composition.

In addition, after the washing step described above is performed, when 0.1 g of the hydrophobic inorganic particles are dispersed in 40 g of the liquid mixture obtained by mixing hexane and water in a volume ratio of 1:1, if a mixed phase of hexane and water is formed, it is preferable that a portion of the hydrophobic inorganic particles exist in the mixed phase.

At this point, it is preferable that 80% by mass or greater of the hydrophobic inorganic particles are transformed to a phase in which hexane is included, and it is further preferable that 85% by mass or greater of the hydrophobic inorganic particles are transformed.

Though the reason is not clear, if the hydrophobic inorganic particles are dispersed in the liquid mixture obtained by mixing hexane and water in a volume ratio of 1:1, a mixed layer of hexane and water is formed in some cases. At this point, a water phase (phase in which hexane is not included) of the liquid mixture of hexane and water becomes transparent. For example, water is introduced to a specific cell in advance, and transmittance is measured at a wavelength of 600 nm, so as to be T1%. Subsequently, a water phase (phase in which hexane is not included) is extracted from the liquid mixture of hexane and water in which the hydrophobic inorganic particles are dispersed, and introduced to a specific cell described above, so as to measure transmittance (T2%) at the wavelength of 600 nm. Also, it is preferable that (T1-T2)/T1 is equal to or greater than 0 and equal to or less than 0.05.

In this manner, if the hydrophobic inorganic particles are dispersed in the liquid mixture obtained by mixing hexane and water in a volume ratio of 1:1, and a mixed layer of hexane and water is formed, though the reason is not clear, the fluidity and the thermal conduction properties of the resin composition is further increased.

In addition, in order to prominently achieve the effect of the invention, the average particle diameter (d₅₀) of the hydrophobic inorganic particles is preferably in a range of 0.1 μm to 100 μm, more preferably in a range of 0.1 μm to 10 μm, and most preferably in a range of 0.1 μm to 5 μm. The average particle diameter can be measured by using a laser diffraction-type particle size distribution measuring device SALD-7000 (laser wavelength: 405 nm) manufactured by Shimazu Corporation, or the like, in conformity with a particle diameter distribution measuring method according to a laser diffraction and scattering method.

(Physical Properties 2)

It is preferable that the hydrophobic inorganic particles have the following physical properties.

From the weight reduction rate measured under the following measurement conditions described below, the number of molecules of the organic compound per 1 nm² of the inorganic particles before the surface treatment calculated by the calculation expression below becomes 1.7 to 20.0.

(Measurement Conditions)
Measurement device: Thermogravimetry-Differential Thermal Analysis (TG-DTA)
Measurement temperature: Temperature increases from 30° C. to 500° C.
Temperature increasing speed: 10° C./min

(Calculation Expression)

If the number of molecules of the organic compound per 1 nm² of inorganic particles is N,

a weight reduction rate (%) is R,

a specific surface area of inorganic particles is S (m²/g), and

a molecular weight of an organic compound is W (g),

N=(6.02×10²³×10⁻¹⁸×R×1)/(W×S×(100−R))

(Where, weight reduction amount (g) per 1 g of hydrophobic inorganic particles=R×1/100).

Specifically, the weight reduction rate R (%) is measured in the following manner.

200 parts by mass of ethanol is added to 1 part by mass of the hydrophobic inorganic particles, ultrasonic washing is performed for 10 minutes, solid-liquid separation is performed, and drying is performed. Thereafter, 40 mg of the hydrophobic inorganic particles were sampled, a weight reduction rate R (reduction rate with respect to weight before the TG-DTA measurement) after the temperature is increased from 30° C. to 500° C. at a temperature increasing speed of 10° C./min under the air current of 200 ml/min is measured with TG-DTA.

In addition, the specific surface area S of the inorganic particles can be measured by a BET method by nitrogen adsorption.

If the number of molecules of the organic compound per 1 nm² of the inorganic particles calculated from the weight reduction rate R is equal to or greater than 1.7, inorganic particle surfaces are sufficiently modified with the organic compound, and the surface modification state of the organic compound becomes in a very satisfactory state. In addition, if the hydrophobic inorganic particles are contained in the resin composition, the state of the interface between the hydrophobic inorganic particles and the matrix resin becomes stable in an optimum state, the fluidity of the resin composition can be increased, and the thermal conduction properties can be also increased.

Meanwhile, in a case where the number of molecules of the organic compound per 1 nm² of the inorganic particles calculated from the weight reduction rate R is equal to or less than 20.0, the surface modification state of the organic compound also becomes a very satisfactory state. Therefore, if the hydrophobic inorganic particles are contained in the resin composition, a state of the interface between the hydrophobic inorganic particles and the matrix resin is stable in an optimum state, and the fluidity of the resin composition can be increased, and the thermal conduction properties can be also increased.

In addition, if the number of molecules of the organic compound per 1 nm² of the inorganic particles calculated from the weight reduction rate R is extremely large, it is considered that the organic compound chemically bonded to the inorganic particles and another organic compound become in any kind of excessive states such as a multilayered structure, through a chemical bond such as the hydrogen bond, and thus hydrophilic groups are in a state of facing the outside. In addition, the excessive organic compounds cause the state of the interface between the hydrophobic inorganic particles and the matrix resin to be unstable, such that it is difficult to obtain the effect on the fluidity and the thermal conduction properties.

Therefore, it is preferable that the number of molecules of the organic compound per 1 nm² of the inorganic particles calculated from the weight reduction rate R is equal to or less than 20.0.

As described above, in a case where the number of molecules of the organic compound per 1 nm² of the inorganic particles calculated from the weight reduction rate R is 1.7 to 20.0, if the hydrophobic inorganic particles are contained in the resin composition, a state of the interface between the hydrophobic inorganic particles and the matrix resin is stable in an optimum state, and the fluidity of the resin composition can be increased, and the thermal conduction properties can be also increased.

In addition, it is more preferable that the number of molecules of the organic compound per 1 nm² of the inorganic particles calculated from the weight reduction rate R is 2.0 to 10.0.

(Manufacturing Method)

Subsequently, the manufacturing method of the hydrophobic inorganic particles is described.

According to the embodiment, the hydrophobic inorganic particles are manufactured by reacting the inorganic particles and the organic compound to each other using the high temperature and high pressure water as a reaction field.

First, the inorganic particles are prepared. For example, it is preferable that hydrophobic inorganic particles are manufactured by using inorganic particles of which the average particle diameter d₅₀ is 0.1 μm to 100 μm. Therefore, the average particle diameter of the hydrophobic inorganic particles becomes 0.1 μm to 100 μm, which is almost the same as that of the raw material inorganic particles as long as the hydrophobic inorganic particles are not condensed.

In addition, the particle size distribution can be measured by gathering the hydrophobic inorganic particles in conformity with JIS M8100, general rules for methods of sampling a powder lump mixed product, adjusting the hydrophobic inorganic particles as a measuring sample in conformity with JIS R 1622-1995, general rules for sample adjustment so as to measure distribution of particle diameters of a fine ceramics raw material, and using a laser diffraction-type particle size distribution measuring device SALD-7000 (laser wavelength: 405 nm) manufactured by Shimazu Corporation in conformity with JIS R 1629-1997, a method for measuring particle diameter distribution by a laser diffraction and scattering method of a fine ceramics raw material.

First, the inorganic particles and the organic compound are added to water (hereinafter, referred to as mixed product)

Also, in a sealed state, the temperature of the mixed product is set to be equal to or greater than 250° C. and equal to or less than 500° C., and the pressure is set to be equal to or greater than 2 MPa and equal to or less than 50 MPa, and preferably be equal to or greater than 2 MPa and equal to or less than 45 MPa. This state may be generally referred to as a supercritical or subcritical state.

In addition, the temperature of the mixed product reaches a predetermined temperature (250° C. to 500° C.) from room temperature (for example, 25° C.) in 3 minutes to 10 minutes, depending on a reaching temperature.

Thereafter, while the pressure applied to the mixed product is caused to be equal to or greater than 2 MPa and equal to or less than 40 MPa, the predetermined temperature is maintained for 3 minutes to 8 minutes, preferably for 3 minutes to 5 minutes. Thereafter, cooling is performed.

Here, if heating is performed for a long time, an organic compound is degraded, and thus it may be difficult to obtain the hydrophobic inorganic particles having high hydrophobicity. Therefore, the heating time at a predetermined temperature is preferably set as described above.

In a state in which water in the mixed product is equal to or greater than 250° C. and equal to or less than 500° C., and the pressure is equal to or greater than 2 MPa and equal to or less than 40 MPa, the inorganic particles and the organic compound are chemically bonded to each other.

When the reaction is performed, as a device for providing a reaction field in high temperature and high pressure, a well-known device may be used by the person having ordinary skill in the art, and for example, a batch-type reaction device such as an autoclave or a circulation-type reaction device can be used. In addition, with respect to a post treatment after the reacting is completed, a step of washing a reaction residue, except for the hydrophobic inorganic particles, such as an unreacted organic compound, a step of extracting the hydrophobic inorganic particles by the solid-liquid separation, a drying step, and a step of cracking condensation are allowed to be suitably performed in the scope in which the effect of the invention is not deteriorated.

A washing agent used in the washing step is not particularly limited, as long as the washing agent can wash the organic compound attached to the hydrophobic inorganic particles, and, for example, alcohol such as methanol, ethanol, and isopropyl alcohol; ketones such as acetone and methyl ethyl ketone; and an aromatic solvent such as toluene and xylene are preferably exemplified. In addition, ultrasonic waves may be used in the washing, if necessary. Further, in the solid-liquid separation step, steps such as filtration and centrifugal separation well known to the person having ordinary skill in the art can be used. In the drying step, methods such as a general normal pressure heating and drying, vacuum drying, and freeze vacuum drying can be used.

The chemical bond between the inorganic particles and the organic compound can be checked by measuring the obtained hydrophobic inorganic particles by thermogravimetry-differential thermal analysis (TG-DTA), fourier transform-type infrared spectroscopy (FT-IR), cross polarization magic angle spinning (CPMAS) NMR, PSTMAS NMR, or the like.

For example, it can be understood that the inorganic particles and the organic compound are chemically bonded to each other in TG-DTA, as described below.

First, 200 parts by mass of ethanol is added to 1 part by mass of the obtained hydrophobic inorganic particles, ultrasonic washing is performed for 10 minutes, the solid-liquid separation is performed, and drying is performed. Accordingly, even if the unreacted organic compound is attached to the hydrophobic inorganic particles, the unreacted organic compound is removed.

Thereafter, if the measurement by TG-DTA is performed, an exothermic peak derived from the organic compound can be observed. If the inorganic particles and the organic compound are not chemically bonded to each other, when ultrasonic washing is performed with ethanol, the organic compound is dissolved in ethanol, and the organic compound is removed by solid-liquid separation. Therefore, the weight reduction is rarely seen in a TG chart, and an exothermic peak is not detected in a DTA chart. In contrast, the exothermic peak is seen, because the inorganic particles and the organic compound are strongly bonded to each other, that is, chemically bonded to each other. Therefore, the organic compound is not volatilized, but burnt.

In addition, the chemical bond between the inorganic particles and the organic compound can be checked by comparing the measurement data of the organic compound by the FT-IR (diffuse reflection method) and the measurement data of the hydrophobic inorganic particles by the FT-IR (diffuse reflection method).

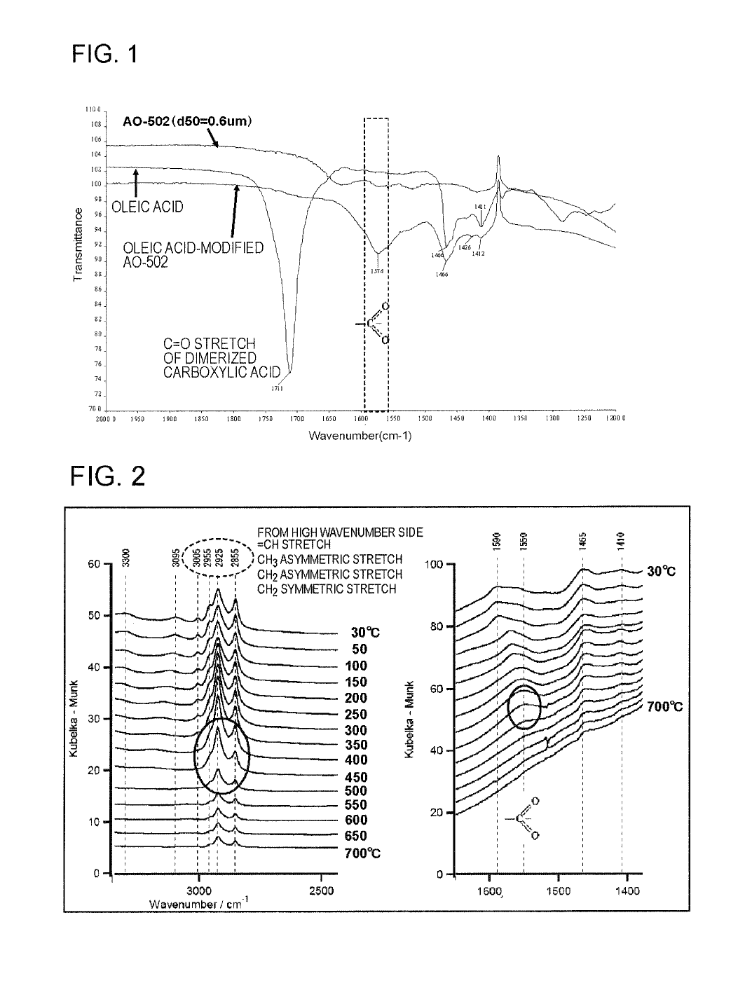

The example (measurement result in room temperature) is illustrated in FIG. 1.

100 mg of AO-502 (average particle diameter: 0.6 μm, specific surface area: 7.5 m²/g) manufactured by Admatechs, 2.5 cc of pure water, and 30 mg of oleic acid were introduced to a tube-type autoclave of 5 cc, and the autoclave was sealed. This was put into a shaking-type heating and stirring device (manufactured by AKICO Corporation), a temperature was caused to increase from room temperature to 400° C. for 5 minutes, and heating was performed for 5 minutes while being shaken at 400° C. The internal pressure of the autoclave at this point became 38 MPa. After the heating was completed, the autoclave was rapidly cooled by using cool water, and the content was extracted to a centrifuge tube of 50 ml. 20 ml of ethanol was added to this, and ultrasonic washing was performed for 10 minutes in order to wash away the unreacted oleic acid. Thereafter, solid-liquid separation was performed under the conditions of 10,000 G, 20° C., and 20 minutes by using a refrigerated centrifuge (3700 manufactured by KUBOTA Corporation). Further, the washing and solid-liquid separation were repeated twice, and the unreacted oleic acid was washed away. This was dispersed again in cyclohexane, drying was performed for 24 hours by using a vacuum freeze dryer (VFD-03 manufactured by AS ONE Corporation), and hydrophobic inorganic particles were obtained. Thereafter, 200 parts by mass of ethanol was added to 1 part by mass of the obtained hydrophobic inorganic particles, ultrasonic washing was performed for 10 minutes, solid-liquid separation was performed, and drying was performed. After the drying, the measurement data of the hydrophobic inorganic particles by the diffuse reflection method (FT-IR) was measured.

As illustrated in FIG. 1, in the data of oleic acid, a peak is seen in a portion of 1,711 cm⁻¹. This indicates that the oleic acid is dimerized. In addition, if the oleic acid exists as a monomer, a peak is seen near 1,760 cm⁻¹.

In contrast, in the hydrophobic inorganic particles, there are no peaks in a portion of 1,711 cm⁻¹ and near 1,760 cm⁻¹, and it is understood that a state of oleic acid does not exist. In addition, in the hydrophobic inorganic particles, there is a peak in a portion of 1,574 cm⁻¹, and this indicates that —COO⁻ exists.

In addition, a peak in an alkyl chain portion was identical to that in a case of oleic acid and a case of hydrophobic inorganic particles.

In addition to this, peaks can be checked by increasing the temperature by the diffuse reflection method (FT-IR), and observing results obtained by performing Kubelka-Munk (K-M) conversion on spectrums at respective temperatures. The example is illustrated in FIG. 2.

The hydrophobic inorganic particles described above are measured at 30° C. to 700° C. by FT-IR. As illustrated in FIG. 2, at 450° C. or greater, a peak in a wavenumber of 3005 cm⁻¹ indicating ═CH stretch, a peak in a wavenumber of 2955 cm⁻¹ indicating CH₃ asymmetric stretch, a peak in a wavenumber of 2925 cm⁻¹ indicating CH₂ asymmetric stretch, and a peak in a wavenumber of 2855 cm⁻¹ indicating CH₂ symmetric stretch decrease. In addition, a peak in a wavenumber of 1,574 cm⁻¹ indicating the existence of —COO⁻ also decreases at 450° C. or greater.

Accordingly, it is understood that the detachment of oleic acid starts at 450° C. or greater. That is, it is understood that the oleic acid and the inorganic particles are strongly bonded to each other, that is, chemically bonded to each other.

In addition, also from 13C-CPMAS NMR of a single body of the organic compound, and 13C-CPMAS NMR and 13C-PSTMAS NMR of the hydrophobic inorganic particles, it is checked that the inorganic particles and the organic compound are chemically bonded to each other.

(Resin Composition)

Subsequently, the resin composition is described.

The resin composition includes the resin and the hydrophobic inorganic particles described above.

The resin composition, for example, is used for a member for heat dissipation and is used for an encapsulating material of a semiconductor device. Also, the resin composition is mounted on the electronic component device as a heat dissipation member.

Herein, as described above, according to the embodiment, the heat dissipation member refers to, for example, a member used in a portion in which heat dissipation properties are required, in an electronic component device such as a semiconductor device or the like in which excellent heat releasability is required. As the portion, for example, an encapsulating material that encapsulates the electronic device that generates heat such as a semiconductor device, an adhesive agent that attaches a semiconductor package to a heat dissipation material such as a heat dissipation fin, or the like are included.

The resin composition according to the embodiment is preferably used for an encapsulating material that encapsulates an electronic device that generates heat such as, particularly, a semiconductor device.

The resin includes, for example, a thermosetting resin. As the thermosetting resin, any one or more kinds of an epoxy resin, a cyanate ester resin, a urea resin, a melamine resin, an unsaturated polyester resin, a bismaleimide resin, a polyurethane resin, a diallyl phthalate resin, a silicone resin, and a resin having a benzoxazine ring may be used.

In addition, a resin corresponding to a curing agent is not included in the thermosetting resin.

The epoxy resin is the entirety of monomers, oligomers, and polymers having two or more epoxy groups in a molecule, and the molecular weight and the molecular structure thereof are not particularly limited.

As the epoxy resin, for example, bifunctional or crystalline epoxy resins such as a biphenyl-type epoxy resin, a bisphenol A-type epoxy resin, a bisphenol F-type epoxy resin, a stilbene-type epoxy resin, and a hydroquinone-type epoxy resin;

a novolac-type epoxy resin such as a cresol novolac-type epoxy resin, a phenol novolac-type epoxy resin, and a naphthol novolac-type epoxy resin;

a phenol aralkyl-type epoxy resin such as a phenylene skeleton-containing phenol aralkyl-type epoxy resin, a biphenylene skeleton-containing phenol aralkyl-type epoxy resin, and a phenylene skeleton-containing naphthol aralkyl-type epoxy resin;

a trifunctional epoxy resin such as a triphenolmethane-type epoxy resin and an alkyl-modified triphenol methane-type epoxy resin;

a modified phenol-type epoxy resin such as a dicyclopentadiene-modified phenol-type epoxy resin and a terpene-modified phenol-type epoxy resin; and

a heterocyclic ring-containing epoxy resin such as a triazine nucleus-containing epoxy resin are included. These may be used singly, or two or more types thereof may be used in combination.

As the cyanate ester resin, for example, products obtained by reacting cyanogen halide compounds and phenols and products obtained by prepolymerizing these by a method such as heating can be used. As specific embodiments, for example, a bisphenol-type cyanate resin such as a novolac-type cyanate resin, a bisphenol A-type cyanate resin, a bisphenol E-type cyanate resin, and a tetramethyl bisphenol F-type cyanate resin can be included. These may be used singly, or two or more types thereof may be used in combination.

The resin composition may include a curing agent, and the curing agent may be appropriately selected according to the kind of the resin.

For example, as the curing agent for the epoxy resin, as long as the curing agent cures the epoxy resin by reaction, products well known to the person having ordinary skill in the art may be used, and, for example, a polyamine compound including dicyandiamide (DICY) or organic acid dihydrazide in addition to an aliphatic polyamine such as diethylenetriamine (DETA), triethylenetetramine (TETA), and meta-xylene diamine (MXDA), aromatic polyamine such as diaminodiphenylmethane (DDM), m-phenylenediamine (MPDA), and diaminodiphenylsulf one (DDS);

acid anhydride including alicyclic acid anhydride such as hexahydrophthalic anhydride (HHPA) and methyl tetrahydrophthalic anhydride (MTHPA), aromatic acid anhydride such as trimellitic anhydride (TMA), pyromellitic anhydride (PMDA), and benzophenone tetracarboxylic acid (BTDA), or the like;

a polyphenol compound such as a phenol aralkyl resin such as a phenylene skeleton-containing phenol aralkyl resin, a biphenylene skeleton-containing phenol aralkyl (that is, biphenylaralkyl) resin, and a phenylene skeleton-containing naphthol aralkyl resin and a bisphenol compound such as bisphenol A;

a polymercaptan compound such as polysulfide, thioester, and thioether;

an isocyanate compound such as isocyanate prepolymer and blocked isocyanate;

an organic acid such as a carboxylic acid-containing polyester resin;

a tertiary amine compound such as benzyldimethylamine (BDMA) and 2,4,6-tridimethylaminomethylphenol (DMP-30);

an imidazole compound such as 2-methylimidazole and 2-ethyl-4-methylimidazole (EMI24); and a Lewis acid such as a BF3 complex;

a phenol resin such as a novolac-type phenol resin and a resole-type phenol resin;

a urea resin such as a methylol group-containing urea resin; and

a melamine resin such as a methylol group-containing melamine resin are included.

Among the curing agents, a phenol-based resin is preferably used. The phenol-based resin used in the embodiment is the entirety of monomers, oligomers, and polymers having two or more phenolic hydroxyl groups in a molecule, and the molecular weight and the molecular structure thereof are not particularly limited. For example, a phenol novolac resin, a cresol novolac resin, a dicyclopentadiene-modified phenol resin, a terpene-modified phenol resin, a triphenolmethane-type resin, and a phenol aralkyl resin (having phenylene skeleton, biphenylene skeleton, or the like) are included. These may be used singly, or two or more types thereof may be used in combination.

Blending amounts of the respective components are appropriately set according to the purpose of the resin composition, but, for example, if the resin is used for an encapsulating material, the inorganic filling material including the hydrophobic inorganic particles is preferably equal to or greater than 80% by mass and equal to or less than 95% by mass with respect to a total amount of the composition. Among them, the inorganic filling material is preferably equal to or greater than 85% by mass and equal to or less than 93% by mass.

The ratio of the hydrophobic inorganic particles in the inorganic filling material is preferably 5% by mass to 30% by mass with respect to the total amount of the inorganic filling material. If the ratio is 5% by mass or greater, a certain amount of particles that contribute to the fluidity of the resin composition and the enhancement of the thermal conduction properties can be secured. The ratio is preferably equal to or less than 30% by mass, because the effect of the invention is prominently achieved.

In addition, the specific surface area of the hydrophobic inorganic particles is not particularly limited, but the specific surface area changes by preferably +30% or less, more preferably +25% or less, and still more preferably +20% or less with respect to the specific surface area of the inorganic particles before the surface treatment. For example, if hydrophobic inorganic particles are composed of particles having particle diameters in the range that includes a maximum point in a range of 0.1 μm to 1 μm and does not include other maximum points, the specific surface area is preferably equal to or greater than 3 (m²/g) and equal to or less than 12 (m²/g). Here, the specific surface area of the hydrophobic inorganic particles is a value measured by the BET method by nitrogen adsorption.

Further, if the inorganic filling material has plural maximum points of the volume-based particle size distribution, in view of the balance between the cost and the performance such as fluidity enhancement of the resin composition, it is preferable that the hydrophobic inorganic particles described above are composed of particles having the particle diameter in a range that has the smallest maximum point and does not have other maximum points.

For example, if the inorganic filling material includes particles having maximum points of the volume-based particle size distribution respectively in a range of 0.1 μm to 1 μm, a range of 3 μm to 8 μm, and a range of 36 μm to 60 μm, particles that have a maximum point in the range of 0.1 μm to 1 μm and do not have other maximum points compose the hydrophobic inorganic particles.

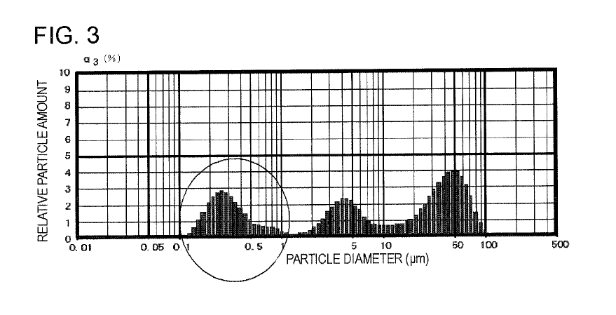

For example, if the inorganic filling material has the particle diameter distribution illustrated in FIG. 3, the hydrophobic inorganic particles preferably have the maximum point of the particle diameter in the range of 0.1 μm to 1 μm.

As described above, if the hydrophobic inorganic particles are composed of particles having the particle diameter in the range that has the smallest maximum point, the viscosity of the resin composition decreases, such that the fluidity can be securely increased.

In addition, if the resin composition is used for the encapsulating material, for example, the thermosetting resin is preferably 1% by mass to 15% by mass, more preferably 2% by mass to 12% by mass, and still more preferably 2% by mass to 10% by mass.

Further, the curing agent is preferably 0.1% by mass to 5% by mass.

Also, the resin composition as described above has excellent fluidity and, at the same time, has excellent thermal conduction properties.

In addition, if necessary, the resin composition may include various additives, such as natural wax such as a curing accelerator or carnauba wax; synthetic wax such as polyethylene wax; a higher fatty acid such as stearic acid or zinc stearate, and metal salts thereof; a release agent such as paraffin; a colorant such as carbon black or red iron oxide; a flame retardant such as a brominated epoxy resin, antimony trioxide, aluminum hydroxide, magnesium hydroxide, zinc borate, zinc molybdate, or phosphazene; an inorganic ion exchanger such as bismuth oxide hydrate; a low stress component such as silicone oil or silicone rubber; or an antioxidant.

In addition, a silane coupling agent may be used in the scope in which the effect of the invention is not deteriorated.

In addition, the invention is not limited to the embodiments described above, and modifications, improvements, or the like in the range in which the object of the invention is achieved are included in the invention.

### EXAMPLES

Subsequently, examples of the invention are described.

### Example 1

### Manufacturing of Hydrophobic Inorganic Particles (Surface-Modified Alumina 1)

100 mg of AO-502 (average particle diameter: 0.6 μm, specific surface area: 7.5 m²/g) manufactured by Admatechs, 2.5 cc of pure water, and 30 mg of lauric acid were mixed and introduced to a tube-type autoclave of 5 cc, and the autoclave was sealed. This was put into a shaking-type heating and stirring device (manufactured by AKICO Corporation), a temperature was caused to increase from room temperature to 400° C. for 5 minutes, and heating was performed for 5 minutes while being shaken at 400° C. The internal pressure of the autoclave at this point became 38 MPa. After the heating was completed, the autoclave was rapidly cooled by using cool water, and the content was extracted to a centrifuge tube of 50 ml. 20 ml of ethanol was added to this, and ultrasonic washing was performed for 10 minutes in order to wash away the unreacted lauric acid. Thereafter, solid-liquid separation was performed under the conditions of 10,000 G, 20° C., and 20 minutes by using a refrigerated centrifuge (3700 manufactured by KUBOTA Corporation). Further, the washing and solid-liquid separation were repeated twice, and the unreacted lauric acid was washed away. This was dispersed again in cyclohexane, drying was performed for 24 hours by using a vacuum freeze dryer (VFD-03 manufactured by AS ONE Corporation), and hydrophobic inorganic particles were obtained. The obtained hydrophobic inorganic particles were evaluated by the following method. The results are presented in Table 1. In addition, in the following examples and comparative examples, the evaluation is performed by the same method.

(Evaluation Method)

(Transformation of Hydrophobic Inorganic Particles to a Phase in which Hexane is Included)

1 part by mass of the obtained hydrophobic inorganic particles and 200 parts by mass of ethanol were mixed, and ultrasonic washing was performed for 10 minutes. Thereafter, the solid-liquid separation was performed under the conditions of 10,000 G, 20° C., and 20 minutes using the refrigerated centrifuge (3700 manufactured by KUBOTA Corporation). Thereafter, drying was performed at 40° C. for 24 hours using a vacuum dryer.

Subsequently, 40 g of the liquid mixture obtained by mixing hexane and water in a volume ratio of 1:1 was introduced to a container, and 0.1 g of the hydrophobic inorganic particles after the ultrasonic washing described above was added. Thereafter, the container was shaken for 30 seconds, and the hydrophobic inorganic particles were dispersed in a transformed solvent using an ultrasonic washing device. Thereafter, the container was stood still for 2 minutes. Since hexane has a smaller specific gravity than water, a phase in which hexane was included was formed on the upper portion of the container, and a phase in which hexane was not included was formed on the lower portion of the container. Thereafter, the phase in which hexane was included was extracted with a pipette or the like, and thus the phase in which hexane was included (if there are a hexane phase and a mixed phase of hexane and water, the mixed phase was included) was separated from the water phase.

Subsequently, the phase in which hexane was included was dried, the hydrophobic inorganic particles were extracted, the weight thereof was measured, and the ratio of the hydrophobic inorganic particles which are transformed to the phase in which hexane was included was calculated.

(Number of Molecules of the Organic Compound Per 1 nm² of the Inorganic Particles Calculated from the Weight Reduction Rate of the Hydrophobic Inorganic Particles)

(Measurement Conditions)
Measurement device: Thermogravimetry-Differential Thermal Analysis (TG-DTA)
Measurement temperature: temperature was increased from 30° C. to 500° C.
Temperature increasing speed: 10° C./min

(Calculation Expression)

If the number of molecules of the organic compound per 1 nm² of the inorganic particles is N,

the weight reduction rate (%) is R,

the specific surface area of the inorganic particles is S (m²/g), and

the molecular weight of the organic compound is W (g),

N=(6.02×10²³×10⁻¹⁸×R×1)/(W×S×(100−R))

(where the weight reduction amount (g) per 1 g of the hydrophobic inorganic particles=R×1/100).

First, the weight reduction rate R (%) was measured.

1 part by mass of the obtained hydrophobic inorganic particles and 200 parts by mass of ethanol were mixed, and ultrasonic washing was performed for 10 minutes. Thereafter, the solid-liquid separation was performed under the conditions of 10,000 G, 20° C., and 20 minutes using the refrigerated centrifuge (3700 manufactured by KUBOTA Corporation). Thereafter, drying was performed at 40° C. for 24 hours using a vacuum dryer. Thereafter, 40 mg of the hydrophobic inorganic particles were sampled, a weight reduction rate R (reduction rate with respect to weight before the TG-DTA measurement) after the temperature was increased from 30° C. to 500° C. at a temperature increasing speed of 10° C./min under the air current of 200 ml/min was measured with TG-DTA.

Further, the specific surface area S of the inorganic particles was measured by the BET method by nitrogen adsorption.

(Manufacturing of Resin Composition)

4.50 parts by mass of Epoxy resin 1 (YX4000K manufactured by Mitsubishi Chemical Corporation), 2.15 parts by mass of Curing agent 1 (MEH-7500 manufactured by Meiwa Plastic Industries, Ltd.), 57.5 parts by mass of spherical alumina (DAW-45 manufactured by Denki Kagaku Kogyo Kabushiki Kaisha, average particle diameter: 45 μm), 25.0 parts by mass of spherical alumina (DAW-05 manufactured by Denki Kagaku Kogyo Kabushiki Kaisha, average particle diameter: 5 μm), 10 parts by mass of the hydrophobic inorganic particles described above (Surface-modified alumina 1), 0.20 parts by mass of Silane coupling agent (KBM-403 manufactured by Shin-Etsu Chemical Co., Ltd.), 0.15 parts by mass of Curing accelerator 1 (triphenylphosphine), 0.20 parts by mass of carnauba wax, and 0.30 parts by mass of carbon black were put into a mixer, and the mixture was mixed for 2 minutes at room temperature. Thereafter, heating and kneading were performed for about 3 minutes with two rollers, and pulverizing after cooling was performed, so as to obtain an epoxy resin composition. The obtained epoxy resin composition was evaluated by the following method. The results are presented in Table 1. In addition, the following examples and comparative examples are evaluated by the same method.

In addition, a required amount of the used hydrophobic inorganic particles were prepared in advance based on the examples.

(Thermal Conductivity of Resin Composition)

The resin composition was injection-molded under the conditions of mold temperature of 175° C., injection pressure of 6.9 MPa, and curing time of 120 seconds using a low pressure transfer molding device, a test specimen (10×10 mm, thickness: 1.0 mm) was manufactured and cured at 175° C. after 2 hours. Thermal diffusivity of the obtained test specimen was measured by using a Xenon flash analyzer LFA447 manufactured by NETZSCH. In addition, the specific gravity of the test specimen used in the measurement of the thermal conductivity was measured by using an electronic specific gravity meter SD-200 L manufactured by Alfa Mirage Co., Ltd., and further the specific heat of the test specimen used in the measurement of the thermal conductivity and the specific gravity was measured by using a differential scanning calorimeter DSC8230 manufactured by Rigaku Corporation. The thermal conductivity was calculated by using the thermal diffusivity, the specific gravity, and the specific heat measured herein. The unit of the thermal conductivity was W/m·K.

A: Thermal conductivity was equal to or greater than 6.0 W/m·K

B: Thermal conductivity was equal to or greater than 5.5 W/m·K and equal to or less than 5.9 W/m·K

C: Thermal conductivity was equal to or greater than 5.0 W/m·K and equal to or less than 5.4 W/m·K

D: Thermal conductivity was less than 5.0 W/m·K

(Spiral Flow of Resin Composition)

The epoxy resin composition was injected to a mold for measuring a spiral flow in conformity with EMMI-1-66, under the conditions of the mold temperature of 175° C., the injection pressure of 6.9 MPa, and a dwelling time of 120 seconds, by using a low pressure transfer molding device (KTS-15 manufactured by Kohtaki Precision Machine Co., Ltd.) and was cured, and a flow length thereof was measured. The unit was cm.

A: Spiral flow length was equal to or greater than 110 cm

B: Spiral flow length was equal to or greater than 90 cm, equal to or less than 109 cm

C: Spiral flow length was equal to or greater than 70 cm, equal to or less than 89 cm

D: Spiral flow length was less than 70 cm

(Particle Size Distribution)

The average particle diameter of the respective particles (particles becoming a raw material of hydrophobic inorganic particles, such as spherical alumina) was measured by gathering an inorganic filling material in conformity with JIS M8100, general rules for methods of sampling a powder lump mixed product, adjusting the inorganic filling material as a measuring sample in conformity with JIS R 1622-1995, general rules for sample adjustment so as to measure distribution of particle diameters of a fine ceramics raw material, and using a laser diffraction-type particle size distribution measuring device SALD-7000 (laser wavelength: 405 nm) manufactured by Shimazu Corporation in conformity with JIS R 1629-1997, a method for measuring particle diameter distribution by a laser diffraction and scattering method of a fine ceramics raw material.

### Example 2

Surface-modified alumina 2 was obtained by using decylamine as an organic compound in the manufacturing of the hydrophobic inorganic particles of Example 1. The others were the same as those in Example 1.

### Example 3

Surface-modified alumina 3 was obtained by using suberic acid as the organic compound in the manufacturing of the hydrophobic inorganic particles of Example 1. The others were the same as in those in Example 1.

### Example 4

Surface-modified alumina 4 was obtained by using oleic acid as the organic compound in the manufacturing of the hydrophobic inorganic particles of Example 1. The others were the same as the manufacturing of the hydrophobic inorganic particles in Example 1.

Thereafter, the resin composition was obtained in the following method.

(Manufacturing of Resin Composition) 4.40 parts by mass of Epoxy resin 1 (YX4000K manufactured by Mitsubishi Chemical Corporation), 2.10 parts by mass of Curing agent 1 (MEH-7500 manufactured by Meiwa Plastic Industries, Ltd.), 57.5 parts by mass of spherical alumina (DAW-45 manufactured by Denki Kagaku Kogyo Kabushiki Kaisha, average particle diameter: 45 μm), 25.0 parts by mass of spherical alumina (DAW-05 manufactured by Denki Kagaku Kogyo Kabushiki Kaisha, average particle diameter: 5 μm), 10 parts by mass of the hydrophobic inorganic particles described above (Surface-modified alumina 4), 0.20 parts by mass of Silane coupling agent 2 (KBM-573 manufactured by Shin-Etsu Chemical Co., Ltd.), 0.3 parts by mass of Curing accelerator 2 (indicated by Formula (1) below), 0.20 parts by mass of carnauba wax, and 0.30 parts by mass of carbon black were put into a mixer, and the mixture was mixed for 2 minutes at room temperature. Thereafter, heating and kneading were performed for about 3 minutes with two rollers, and pulverizing after cooling was performed, so as to obtain an epoxy resin composition.

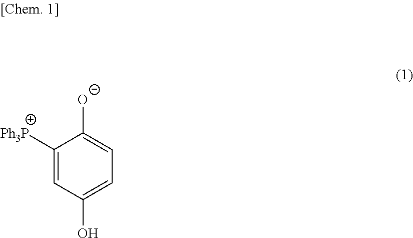

### Example 5

Oleic acid was used as the organic compound in the manufacturing of the hydrophobic inorganic particles of Example 1, and the used amount of the oleic acid was 5 mg. Accordingly, Surface-modified alumina 5 was obtained. The others were the same as in the manufacturing of the hydrophobic inorganic particles of Example 1.

Thereafter, the hydrophobic inorganic particles were obtained by the following method.

(Manufacturing of Resin Composition)

4.33 parts by mass of Epoxy resin 1 (YX4000K manufactured by Mitsubishi Chemical Corporation), 2.07 parts by mass of Curing agent 1 (MEH-7500 manufactured by Meiwa Plastic Industries, Ltd.), 57.5 parts by mass of spherical alumina (DAW-45 manufactured by Denki Kagaku Kogyo Kabushiki Kaisha, average particle diameter: 45 μm), 25.0 parts by mass of spherical alumina (DAW-05 manufactured by Denki Kagaku Kogyo Kabushiki Kaisha, average particle diameter: 5 μm), 10 parts by mass of the hydrophobic inorganic particles described above (Surface-modified alumina 5), 0.20 parts by mass of Silane coupling agent 2 (KBM-573 manufactured by Shin-Etsu Chemical Co., Ltd.), 0.4 parts by mass of Curing accelerator 3 (indicated by Formula (2) below), 0.20 parts by mass of carnauba wax, and 0.30 parts by mass of carbon black were put into a mixer, and the mixture was mixed for 2 minutes at room temperature. Thereafter, heating and kneading were performed for about 3 minutes with two rollers, and pulverizing after cooling was performed, so as to obtain an epoxy resin composition.

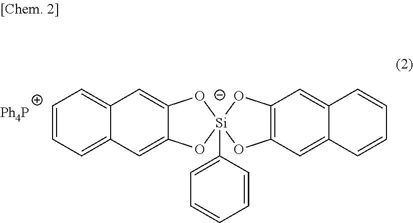

### Example 6

Linoleic acid was used as the organic compound in the manufacturing of the hydrophobic inorganic particles of Example 1. Accordingly, Surface-modified alumina 6 was obtained. The others were the same as those in Example 1.

### Example 7

Oleylamine was used as the organic compound in the manufacturing of the hydrophobic inorganic particles of Example 1. Accordingly, Surface-modified alumina 7 was obtained. The others were the same as those in Example 1.

### Example 8

Terephthalic acid was used as the organic compound in the manufacturing of the hydrophobic inorganic particles of Example 1. Accordingly, Surface-modified alumina 8 was obtained. The others were the same as those in Example 1.

### Example 9

Hydroxybenzoic acid was used as the organic compound in the manufacturing of the hydrophobic inorganic particles of Example 1. Accordingly, Surface-modified alumina 9 was obtained. The others were the same as those in Example 1.

### Example 10

A phenol novolac resin (Product name: PR-HF-3 manufactured by Sumitomo Bakelite Co., Ltd.) was used as the organic compound in the manufacturing of the hydrophobic inorganic particles of Example 1. Accordingly, Surface-modified alumina 10 was obtained. The others were the same as those in Example 1.

### Example 11

Spherical silica (average particle diameter: 0.5 μm, specific surface area: 5.5 m²/g) of which the product name is SO-E2 manufactured by Admatechs was used as inorganic particles in the manufacturing of the hydrophobic inorganic particles of Example 1. Oleic acid was used as the organic compound. Accordingly, Surface-modified silica 1 was obtained. The others were the same as in the manufacturing of the hydrophobic inorganic particles of Example 1.

Thereafter, the resin composition was obtained in the following method.

(Manufacturing of Resin Composition)

3.75 parts by mass of Epoxy resin 2 (NC-3000 manufactured by Nippon Kayaku Co., Ltd.), 2.76 parts by mass of Curing agent 2 (MEH-7851SS manufactured by Meiwa Plastic Industries, Ltd.), 57.5 parts by mass of spherical alumina (DAW-45 manufactured by Denki Kagaku Kogyo Kabushiki Kaisha, average particle diameter: 45 μm), 25.0 parts by mass of spherical alumina (DAW-05 manufactured by Denki Kagaku Kogyo Kabushiki Kaisha, average particle diameter: 5 μm), 10 parts by mass of the hydrophobic inorganic particles described above (Surface-modified silica 1), 0.20 parts by mass of Silane coupling agent 2 (KBM-573 manufactured by Shin-Etsu Chemical Co., Ltd.), 0.3 parts by mass of Curing accelerator 2 (indicated by Formula (1)), 0.20 parts by mass of carnauba wax, and 0.30 parts by mass of carbon black were put into a mixer, and the mixture was mixed for 2 minutes at room temperature. Thereafter, heating and kneading were performed for about 3 minutes with two rollers, and pulverizing after cooling was performed, so as to obtain an epoxy resin composition.

### Example 12

### Manufacturing of Hydrophobic Inorganic Particles (Surface-Modified Alumina 11)

100 mg of AO-502 (average particle diameter: 0.6 μm, specific surface area: 7.5 m²/g) manufactured by Admatechs, 2.5 cc of pure water, and 30 mg of suberic acid were mixed and introduced to a tube-type autoclave of 5 cc, and the autoclave was sealed. This was put into a shaking-type heating and stirring device (manufactured by AKICO Corporation), a temperature was caused to increase from room temperature to 300° C. for 5 minutes, and heating was performed for 5 minutes while being shaken at 300° C. The internal pressure of the autoclave at this point became 8.5 MPa. After the heating was completed, the autoclave was rapidly cooled by using cool water, and the content was extracted to a centrifuge tube of 50 ml. 20 ml (20% by mass with respect to 100 parts by mass of the hydrophobic inorganic particles) of ethanol was added to this, and ultrasonic washing was performed for 10 minutes in order to wash away the unreacted suberic acid. Thereafter, solid-liquid separation was performed under the conditions of 10,000 G, 20° C., and 20 minutes by using a refrigerated centrifuge (3700 manufactured by KUBOTA Corporation). Further, the washing and solid-liquid separation were repeated twice, and the unreacted suberic acid was washed away. This was dispersed again in cyclohexane, drying was performed for 24 hours by using a vacuum freeze dryer (VFD-03 manufactured by AS ONE Corporation), and hydrophobic inorganic particles were obtained.

Thereafter, the resin composition was obtained in the same manner as in Example 1 except that Surface-modified alumina 11 was used.

### Comparative Example 1

### Manufacturing of Hydrophobic Inorganic Particles (Surface-Modified Alumina 12)

100 mg of AO-502 (average particle diameter: 0.6 μm, specific surface area: 7.5 m²/g) manufactured by Admatechs, 2.5 cc of pure water, and 100 mg of adipic acid were introduced to a tube-type autoclave of 5 cc, and the autoclave was sealed. This was put into a shaking-type heating and stirring device (manufactured by AKICO Corporation) heated to 400° C. in advance, and heating was performed for 20 minutes while being shaken at 400° C. The internal pressure of the autoclave at this point became 38 MPa. After the heating was completed, the autoclave was rapidly cooled by using cool water, and the content was extracted to a centrifuge tube of 50 ml. 20 ml of ethanol was added to this, and ultrasonic washing was performed for 10 minutes in order to wash away the unreacted adipic acid. Thereafter, solid-liquid separation was performed under the conditions of 10,000 G, 20° C., and 20 minutes by using a refrigerated centrifuge (3700 manufactured by KUBOTA Corporation). Further, the washing and solid-liquid separation were repeated twice, and the unreacted adipic acid was washed away. This was dispersed again in cyclohexane, drying was performed for 24 hours by using a vacuum freeze dryer (VFD-03 manufactured by AS ONE Corporation), and hydrophobic inorganic particles were obtained.

The resin composition was obtained in the same manner as in Example 1 except that using Surface-modified alumina 12 was used.

### Comparative Example 2

### Manufacturing of Hydrophobic Inorganic Particles (Surface-Modified Alumina 13)

100 mg of AO-502 (average particle diameter: 0.6 μm, specific surface area: 7.5 m²/g) manufactured by Admatechs, 2.5 cc of pure water, and 2 mg of terephthalic acid were introduced to a tube-type autoclave of 5 cc, and the autoclave was sealed. Heating was performed in the same manner as in Example 1. After the heating was completed, ethanol washing, solid-liquid separation, and freeze-drying were performed in the same manner as in Surface-modified alumina 1, so as to obtain Surface-modified alumina 13.

Thereafter, the resin composition was prepared in the same manner as in Example 1.

### Comparative Example 3

AO-502 (average particle diameter: 0.6 μm, specific surface area: 7.5 m²/g) manufactured by Admatechs used in the manufacturing of the hydrophobic inorganic particles of Example 1 was used without modification with the organic compound.

Specifics are as follows. 4.50 parts by mass of Epoxy resin 1 (YX4000K manufactured by Mitsubishi Chemical Corporation), 2.15 parts by mass of Curing agent 1 (MEH-7500 manufactured by Meiwa Plastic Industries, Ltd.), 57.5 parts by mass of spherical alumina (DAW-45 manufactured by Denki Kagaku Kogyo Kabushiki Kaisha, average particle diameter: 45 μm), 25.0 parts by mass of spherical alumina (DAW-05 manufactured by Denki Kagaku Kogyo Kabushiki Kaisha, average particle diameter: 5 μm), 10 parts by mass of AO-502 manufactured by Admatechs, 0.20 parts by mass of Silane coupling agent 1 (KBM-403 manufactured by Shin-Etsu Chemical Co., Ltd.), 0.15 parts by mass of Curing accelerator 1 (triphenylphosphine), 0.20 parts by mass of carnauba wax, and 0.30 parts by mass of carbon black were put into a mixer, and the mixture was mixed for 2 minutes at room temperature. Thereafter, heating and kneading were performed for about 3 minutes with two rollers, and pulverizing after cooling was performed, so as to obtain an epoxy resin composition.

### Comparative Example 4

Spherical silica of which the product name is SO-E2 manufactured by Admatechs (average particle diameter: 0.5 μm, specific surface area: 5.5 m²/g) was used without modification with the organic compound.

Specifics are as follows.

3.75 parts by mass of Epoxy resin 2 (NC-3000 manufactured by Nippon Kayaku Co., Ltd.), 2.76 parts by mass of Curing agent 2 (MEH-7851SS manufactured by Meiwa Plastic Industries, Ltd.), 57.5 parts by mass of spherical alumina (DAW-45 manufactured by Denki Kagaku Kogyo Kabushiki Kaisha, average particle diameter: 45 μm), 25.0 parts by mass of spherical alumina (DAW-05 manufactured by Denki Kagaku Kogyo Kabushiki Kaisha, average particle diameter: 5 μm), 10 parts by mass of spherical silica described above, 0.20 parts by mass of Silane coupling agent 2 (KBM-573 manufactured by Shin-Etsu Chemical Co., Ltd.), 0.3 parts by mass of Curing accelerator 2 (indicated by Formula (1)), 0.20 parts by mass of carnauba wax, and 0.30 parts by mass of carbon black were put into a mixer, and the mixture was mixed for 2 minutes at room temperature. Thereafter, heating and kneading were performed for about 3 minutes with two rollers, and pulverizing after cooling was performed, so as to obtain an epoxy resin composition.

### Comparative Example 5

10 g of AO-502 (average particle diameter: 0.6 μm, specific surface area: 7.5 m²/g) manufactured by Admatechs and 3 g of oleic acid were put into a mixer, and the mixture was mixed for 2 minutes at room temperature. 130 mg of the obtained content was sampled and was put into a centrifuge tube of 50 ml. 20 ml of ethanol was added to this, and ultrasonic washing was performed for 10 minutes in order to wash away the unreacted oleic acid. Thereafter, solid-liquid separation was performed under the conditions of 10,000 G, 20° C., and 20 minutes by using a refrigerated centrifuge (3700 manufactured by KUBOTA Corporation). Further, the washing and solid-liquid separation were repeated twice, and the unreacted oleic acid was washed away. This was dispersed again in cyclohexane, drying was performed for 24 hours by using a vacuum freeze dryer (VFD-03 manufactured by AS ONE Corporation), and Surface-modified alumina 14 was obtained. The manufacturing of the resin composition is the same as that in Example 4 except that Surface-modified alumina 4 was changed to Surface-modified alumina 14.

### Comparative Example 6

10 g of AO-502 (average particle diameter: 0.6 μm, specific surface area: 7.5 m²/g) manufactured by Admatechs and 1.5 g of a silane coupling agent 2 (KBM-573 manufactured by Shin-Etsu Chemical Co., Ltd.) were put into a mixer, and the mixture was mixed for 2 minutes at room temperature. 1.5 g of oleic acid was added to the particles obtained herein, and the mixture was mixed for 2 minutes at room temperature with the same mixer. 130 mg of the obtained content was sampled and was put into a centrifuge tube of 50 ml. 20 ml of ethanol was added to this, and ultrasonic washing was performed for 10 minutes in order to wash away the unreacted silane coupling agent and unreacted oleic acid. Thereafter, solid-liquid separation was performed under the conditions of 10,000 G, 20° C., and 20 minutes by using a refrigerated centrifuge (3700 manufactured by KUBOTA Corporation). Further, the washing and solid-liquid separation were repeated twice, and the unreacted silane coupling agent and unreacted oleic acid was washed away. This was dispersed again in cyclohexane, drying was performed for 24 hours by using a vacuum freeze dryer (VFD-03 manufactured by AS ONE Corporation), and Surface-modified alumina 15 was obtained. The manufacturing of the resin composition is the same as that in Example 4 except that Surface-modified alumina 4 was changed to Surface-modified alumina 15.

(Results)

The results of the examples and the comparative examples are presented in Tables 1 and 2.

TABLE 1

| | | | | Exam- | Exam- | Exam- | Exam- | Exam- | Exam- | Exam- | Exam- | Exam- |
|---|---|---|---|---|---|---|---|---|---|---|---|---|
| | | | | ple 1 | ple 2 | ple 3 | ple 4 | ple 5 | ple 6 | ple 7 | ple 8 | ple 9 |
| Hydrophobic | Organic compound | | | Lauric | Decyl | Suberic | Oleic | Oleic | Linoleic | Oleyl | Tere- | Hydroxy |
| inorganic | | | | acid | amine | acid | acid | acid | acid | amine | phthalic | benzoic |
| particles | | | | | | | | | | | acid | acid |
| | Amount of organic compound with | | | 30 | 30 | 30 | 30 | 5 | 30 | 30 | 30 | 30 |
| | respect to 100 parts by mass of | | | | | | | | | | | |
| | inorganic particles (parts by mass) | | | | | | | | | | | |
| | (Parts by | Product | Manu- | | | | | | | | | |
| | mass) | Number | facturer | | | | | | | | | |
| Resin | Epoxy | YK4000K | Mitsubishi | 4.50 | 4.50 | 4.50 | 4.40 | 4.33 | 4.50 | 4.50 | 4.50 | 4.50 |
| composition | resin 1 | | Chemical | | | | | | | | | |
| | | | Corporation | | | | | | | | | |
| | Epoxy | NC3000 | Nippon | | | | | | | | | |
| | resin 2 | | Kayaku | | | | | | | | | |
| | | | Co., Ltd. | | | | | | | | | |
| | Curing | MEH- | Meiwa | 2.15 | 2.15 | 2.15 | 2.10 | 2.07 | 2.15 | 2.15 | 2.15 | 2.15 |
| | agent 1 | 7500 | Plastic | | | | | | | | | |
| | | | Industries, | | | | | | | | | |
| | | | Ltd. | | | | | | | | | |
| | Curing | MEH- | Meiwa | | | | | | | | | |
| | agent 2 | 7851SS | Plastic | | | | | | | | | |
| | | | Industries, | | | | | | | | | |
| | | | Ltd. | | | | | | | | | |
| | Spherical | Average | Denki | 57.50 | 57.50 | 57.50 | 57.50 | 57.50 | 57.50 | 57.50 | 57.50 | 57.50 |
| | alumina | particle | Kagaku | | | | | | | | | |
| | DAW-45 | diameter: | Kogyo | | | | | | | | | |
| | | 45 μm | Kabushiki | | | | | | | | | |
| | | | Kaisha | | | | | | | | | |
| | Spherical | Average | Denki | 25.00 | 25.00 | 25.00 | 25.00 | 25.00 | 25.00 | 25.00 | 25.00 | 25.00 |
| | alumina | particle | Kagaku | | | | | | | | | |
| | DAW-05 | diameter: | Kogyo | | | | | | | | | |
| | | 5 μm | Kabushiki | | | | | | | | | |
| | | | Kaisha | | | | | | | | | |
| | Surface- | | | 10.00 | | | | | | | | |
| | modified | | | | | | | | | | | |
| | alumina 1 | | | | | | | | | | | |
| | Surface- | | | | 10.00 | | | | | | | |
| | modified | | | | | | | | | | | |
| | alumina 2 | | | | | | | | | | | |
| | Surface- | | | | | 10.00 | | | | | | |
| | modified | | | | | | | | | | | |
| | alumina 3 | | | | | | | | | | | |
| | Surface- | | | | | | 10.00 | | | | | |
| | modified | | | | | | | | | | | |
| | alumina 4 | | | | | | | | | | | |
| | Surface- | | | | | | | 10.00 | | | | |
| | modified | | | | | | | | | | | |
| | alumina 5 | | | | | | | | | | | |
| | Surface- | | | | | | | | 10.00 | | | |
| | modified | | | | | | | | | | | |
| | alumina 6 | | | | | | | | | | | |
| | Surface- | | | | | | | | | 10.00 | | |
| | modified | | | | | | | | | | | |
| | alumina 7 | | | | | | | | | | | |
| | Surface- | | | | | | | | | | 10.00 | |
| | modified | | | | | | | | | | | |
| | alumina 8 | | | | | | | | | | | |
| | Surface- | | | | | | | | | | | 10.00 |
| | modified | | | | | | | | | | | |
| | alumina 9 | | | | | | | | | | | |
| | Surface- | | | | | | | | | | | |
| | modified | | | | | | | | | | | |
| | alumina 10 | | | | | | | | | | | |
| | Surface- | | | | | | | | | | | |
| | modified | | | | | | | | | | | |
| | silica 1 | | | | | | | | | | | |
| | Surface- | | | | | | | | | | | |
| | modified | | | | | | | | | | | |
| | alumina 11 | | | | | | | | | | | |
| | Surface- | | | | | | | | | | | |
| | modified | | | | | | | | | | | |
| | alumina 12 | | | | | | | | | | | |
| | Surface- | | | | | | | | | | | |
| | modified | | | | | | | | | | | |
| | alumina 13 | | | | | | | | | | | |
| | Surface- | | | | | | | | | | | |
| | modified | | | | | | | | | | | |
| | alumina 14 | | | | | | | | | | | |
| | Surface- | | | | | | | | | | | |
| | modified | | | | | | | | | | | |
| | alumina 15 | | | | | | | | | | | |
| | Unmodified | Average | Admatechs | | | | | | | | | |
| | alumina | particle | | | | | | | | | | |
| | AO-502 | diameter: | | | | | | | | | | |
| | | 0.6 μm | | | | | | | | | | |
| | Unmodified | Average | Admatechs | | | | | | | | | |
| | Silica | particle | | | | | | | | | | |
| | | diameter: | | | | | | | | | | |
| | | 0.5 μm | | | | | | | | | | |
| | Silane | KBM-403 | Shin-Etsu | 0.20 | 0.20 | 0.20 | | | 0.20 | 0.20 | 0.20 | 0.20 |
| | coupling | | Chemical | | | | | | | | | |
| | agent 1 | | Co., Ltd. | | | | | | | | | |
| | Silane | KBM-573 | Shin-Etsu | | | | 0.20 | 0.20 | | | | |
| | coupling | | Chemical | | | | | | | | | |
| | agent 2 | | Co., Ltd. | | | | | | | | | |
| | Curing | Triphenyl | | 0.15 | 0.15 | 0.15 | | | 0.15 | 0.15 | 0.15 | 0.15 |
| | accelerator | phosphine | | | | | | | | | | |
| | 1 | | | | | | | | | | | |
| | Curing | Formula | | | | | 0.30 | | | | | |
| | accelerator | (1) | | | | | | | | | | |
| | 1 | | | | | | | | | | | |
| | Curing | Formula | | | | | | 0.40 | | | | |
| | accelerator | (2) | | | | | | | | | | |
| | 3 | | | | | | | | | | | |
| | Carnauba | | | 0.20 | 0.20 | 0.20 | 0.20 | 0.20 | 0.20 | 0.20 | 0.20 | 0.20 |
| | wax | | | | | | | | | | | |
| | Carbon | | | 0.30 | 0.30 | 0.30 | 0.30 | 0.30 | 0.30 | 0.30 | 0.30 | 0.30 |
| | black | | | | | | | | | | | |

| | | | | | | | | | | |
|---|---|---|---|---|---|---|---|---|---|---|
| Evaluation | Transformation rate to a phase | 95 | 90 | 86 | >99 | >99 | 99 | 99 | 94 | 89 |
| Result | in which hexane is included (%) | | | | | | | | | |
| | Weight reduction rate R (%) | 1.3 | 0.9 | 1.4 | 1.3 | 0.7 | 1.8 | 1.7 | 1.5 | 1.5 |
| | Specific surface area of inorganic | 7.5 | 7.5 | 7.5 | 7.5 | 7.5 | 7.5 | 7.5 | 7.5 | 7.5 |
| | particles (m²/g) | | | | | | | | | |
| | Number of molecules of organic | 5.2 | 4.6 | 6.5 | 3.7 | 2.0 | 5.2 | 5.1 | 7.2 | 8.7 |
| | compound per 1 nm² of inorganic | | | | | | | | | |
| | particles (number) | | | | | | | | | |
| | Specific surface area of hydrophobic | 6.8 | 6.6 | 6.5 | 6.8 | 6.8 | 6.8 | 6.5 | 6.4 | 6.4 |
| | inorganic particles (m²/g) | | | | | | | | | |
| | Thermal conductivity (W/m · K) | A | A | B | A | A | A | A | A | B |
| | Spiral flow (cm) | B | B | B | A | A | B | B | B | B |

TABLE 2

| | | | | | | | Comp. | Comp. | Comp. | Comp. | Comp. | Comp. |
|---|---|---|---|---|---|---|---|---|---|---|---|---|
| | | | | Exam- | Exam- | Exam- | Exam- | Exam- | Exam- | Exam- | Exam- | Exam- |
| | | | | ple 10 | ple 11 | ple 12 | ple 1 | ple 2 | ple 3 | ple 4 | ple 5 | ple 6 |
| Hydrophobic | Organic compound | | | Phenol | Oleic | Suberic | Adipic | Tere- | Un- | Un- | Oleic | KBM- |
| inorganic | | | | novolac | acid | acid | acid | phthalic | treated | treated | acid | 573 + |
| particles | | | | | | | | acid | | | | Oleic |
| | | | | | | | | | | | | acid |
| | Amount of organic compound with | | | 30 | 30 | 30 | 100 | 2 | | | 30 | 30 |
| | respect to 100 parts by mass of | | | | | | | | | | | |
| | inorganic particles (parts by mass) | | | | | | | | | | | |
| | (Parts by | Product | Manu- | | | | | | | | | |
| | mass) | Number | facturer | | | | | | | | | |
| Resin | Epoxy | YK4000K | Mitsubishi | 4.50 | | 4.50 | 4.50 | 4.50 | 4.50 | | 4.40 | 4.40 |
| Composition | resin 1 | | Chemical | | | | | | | | | |
| | | | Corporation | | | | | | | | | |
| | Epoxy | NC3000 | Nippon | | 3.75 | | | | | 3.75 | | |
| | resin 2 | | Kayaku | | | | | | | | | |
| | | | Co., Ltd. | | | | | | | | | |
| | Curing | MEH- | Meiwa | 2.15 | | 2.15 | 2.15 | 2.15 | 2.15 | | 2.10 | 2.10 |
| | agent 1 | 7500 | Plastic | | | | | | | | | |
| | | | Industries, | | | | | | | | | |
| | | | Ltd. | | | | | | | | | |
| | Curing | MEH- | Meiwa | | 2.76 | | | | | 2.76 | | |
| | agent 2 | 7851SS | Plastic | | | | | | | | | |
| | | | Industries, | | | | | | | | | |
| | | | Ltd. | | | | | | | | | |
| | Spherical | Average | Denki | 57.50 | 57.50 | 57.50 | 57.50 | 57.50 | 57.50 | 57.50 | 57.50 | 57.50 |
| | alumina | particle | Kagaku | | | | | | | | | |
| | DAW-45 | diameter: | Kogyo | | | | | | | | | |
| | | 45 μm | Kabushiki | | | | | | | | | |
| | | | Kaisha | | | | | | | | | |
| | Spherical | Average | Denki | 25.00 | 25.00 | 25.00 | 25.00 | 25.00 | 25.00 | 25.00 | 25.00 | 25.00 |
| | alumina | particle | Kagaku | | | | | | | | | |
| | DAW-05 | diameter: | Kogyo | | | | | | | | | |
| | | 5 μm | Kabushiki | | | | | | | | | |
| | | | Kaisha | | | | | | | | | |
| | Surface- | | | | | | | | | | | |
| | modified | | | | | | | | | | | |
| | alumina 1 | | | | | | | | | | | |
| | Surface- | | | | | | | | | | | |
| | modified | | | | | | | | | | | |
| | alumina 2 | | | | | | | | | | | |
| | Surface- | | | | | | | | | | | |
| | modified | | | | | | | | | | | |
| | alumina 3 | | | | | | | | | | | |
| | Surface- | | | | | | | | | | | |
| | modified | | | | | | | | | | | |
| | alumina 4 | | | | | | | | | | | |
| | Surface- | | | | | | | | | | | |
| | modified | | | | | | | | | | | |
| | alumina 5 | | | | | | | | | | | |
| | Surface- | | | | | | | | | | | |
| | modified | | | | | | | | | | | |
| | alumina 6 | | | | | | | | | | | |
| | Surface- | | | | | | | | | | | |
| | modified | | | | | | | | | | | |
| | alumina 7 | | | | | | | | | | | |
| | Surface- | | | | | | | | | | | |
| | modified | | | | | | | | | | | |
| | alumina 8 | | | | | | | | | | | |
| | Surface- | | | | | | | | | | | |
| | modified | | | | | | | | | | | |
| | alumina 9 | | | | | | | | | | | |
| | Surface- | | | 10.00 | | | | | | | | |
| | modified | | | | | | | | | | | |
| | alumina 10 | | | | | | | | | | | |
| | Surface- | | | | 10.00 | | | | | | | |
| | modified | | | | | | | | | | | |
| | silica 1 | | | | | | | | | | | |
| | Surface- | | | | | 10.00 | | | | | | |
| | modified | | | | | | | | | | | |
| | alumina 11 | | | | | | | | | | | |
| | Surface- | | | | | | 10.00 | | | | | |
| | modified | | | | | | | | | | | |
| | alumina 12 | | | | | | | | | | | |
| | Surface- | | | | | | | 10.00 | | | | |
| | modified | | | | | | | | | | | |
| | alumina 13 | | | | | | | | | | | |
| | Surface- | | | | | | | | | | 10.00 | |
| | modified | | | | | | | | | | | |
| | alumina 14 | | | | | | | | | | | |
| | Surface- | | | | | | | | | | | 10.00 |
| | modified | | | | | | | | | | | |
| | alumina 15 | | | | | | | | | | | |
| | Unmodified | Average | Admatechs | | | | | | 10.00 | | | |
| | alumina | particle | | | | | | | | | | |
| | AO-502 | diameter: | | | | | | | | | | |
| | | 0.6 μm | | | | | | | | | | |
| | Unmodified | Average | Admatechs | | | | | | | 10.00 | | |
| | Silica | particle | | | | | | | | | | |
| | | diameter: | | | | | | | | | | |
| | | 0.5 μm | | | | | | | | | | |
| | Silane | KBM-403 | Shin-Etsu | 0.20 | | 0.20 | 0.20 | 0.20 | 0.20 | | | |
| | coupling | | Chemical | | | | | | | | | |
| | agent 1 | | Co., Ltd. | | | | | | | | | |
| | Silane | KBM-573 | Shin-Etsu | | 0.20 | | | | | 0.20 | 0.20 | 0.20 |
| | coupling | | Chemical | | | | | | | | | |
| | agent 2 | | Co., Ltd. | | | | | | | | | |
| | Curing | Triphenyl- | | 0.15 | | 0.15 | 0.15 | 0.15 | 0.15 | | | |
| | accelerator | phosphine | | | | | | | | | | |
| | 1 | | | | | | | | | | | |
| | Curing | Formula | | | 0.30 | | | | | 0.30 | 0.30 | 0.30 |
| | accelerator | (1) | | | | | | | | | | |
| | 2 | | | | | | | | | | | |
| | Curing | Formula | | | | | | | | | | |
| | accelerator | (2) | | | | | | | | | | |
| | 3 | | | | | | | | | | | |
| | Carnauba | | | 0.20 | 0.20 | 0.20 | 0.20 | 0.20 | 0.20 | 0.20 | 0.20 | 0.20 |
| | wax | | | | | | | | | | | |
| | Carbon | | | 0.30 | 0.30 | 0.30 | 0.30 | 0.30 | 0.30 | 0.30 | 0.30 | 0.30 |
| | black | | | | | | | | | | | |

| | | | | | | | | | | |
|---|---|---|---|---|---|---|---|---|---|---|
| Evaluation | Transformation rate to a phase | 87 | >99 | 57 | 48 | 11 | 0 | 0 | 20 | 30 |
| Result | in which hexane is included (%) | | | | | | | | | |
| | Weight reduction rate R (%) | 5.2 | 1.2 | 3.5 | 4.4 | 0.3 | 0 | 0 | 0.2 | 0.2 |
| | Specific surface area of inorganic | 7.5 | 5.5 | 7.5 | 7.5 | 7.5 | 7.5 | 5.5 | 7.5 | 7.5 |
| | particles (m²/g) | | | | | | | | | |
| | Number of molecules of organic | 7.0 | 4.7 | 16.1 | 24.2 | 1.4 | 0.0 | 0.0 | 0.6 | 0.6 |
| | compound per 1 nm² of inorganic | | | | | | | | | |
| | particles (number) | | | | | | | | | |
| | Specific surface area of hydrophobic | 6.5 | 4.6 | 6.5 | 6.5 | 6.5 | — | — | 6.7 | 6.6 |
| | inorganic particles (m²/g) | | | | | | | | | |
| | Thermal conductivity (W/m · K) | B | C | C | D | D | D | D | D | D |
| | Spiral flow (cm) | B | A | B | C | D | D | B | C | C |

In Examples 1 to 12 in which the number of molecules of the organic compound per 1 nm² of hydrophobic inorganic particles, which is calculated from a weight reduction rate of the hydrophobic inorganic particles, is 1.7 to 20.0, thermal conductivity was high, the value of the spiral flow was also significant, and the fluidity was high.

In contrast, in Comparative Example 1 in which the number of molecules of the organic compound per 1 nm² of hydrophobic inorganic particles, which is calculated from the weight reduction rate of the hydrophobic inorganic particles, is 24.2, thermal conductivity and the value of the spiral flow were deteriorated, compared with Examples 1 to 12.

In addition, in Comparative Example 2 in which the number of molecules of the organic compound per 1 nm² of hydrophobic inorganic particles, which is calculated from the weight reduction rate of the hydrophobic inorganic particles, is 1.4, thermal conductivity and the value of the spiral flow were deteriorated, compared with Examples 1 to 12.

In addition, in Comparative Examples 3 to 6, balance between thermal conductivity and the fluidity was bad.

In addition, in Examples 1 to 12, a mixed phase of hexane and water was formed, and a portion of the hydrophobic inorganic particles existed in the mixed phase.

In addition, it was found that excellent filling properties and high heat dissipation properties were compatible with each other in an electronic component device of a power semiconductor device or the like, which is manufactured by using the resin composition according to the invention.

This application claims priority based on Japanese Patent Application No. 2013-114552, filed on May 30, 2013, and the content of the above application is incorporated herein by reference in its entirety.

1. Hydrophobic inorganic particles obtained by surface-modifying inorganic particles with an organic compound,
wherein with respect to the hydrophobic inorganic particles subjected to a washing step described below, a weight reduction rate is calculated under measurement conditions described below, and the number of molecules of the organic compound per 1 nm² of inorganic particles before a surface treatment, which is calculated by a calculation expression described below, is 1.7 to 20.0:
washing step:
200 parts by mass of ethanol is added to 1 part by mass of the hydrophobic inorganic particles, ultrasonic washing is performed for 10 minutes, solid-liquid separation is performed, and drying is performed;
measurement conditions:
Measurement device: Thermogravimetry-Differential Thermal Analysis (TG-DTA);
Environment: Atmospheric environment;
Measurement temperature: Temperature increases from 30° C. to 500° C.; and
Temperature increasing speed: 10° C./min;
calculation expression:
if the number of molecules of the organic compound per 1 nm² of inorganic particles is N,
a weight reduction rate (%) is R,
a specific surface area of inorganic particles is S (m²/g), and
a molecular weight of organic compound is W (g), then
N=(6.02×10²³×10⁻¹⁸×R×1)/(W×S×(100−R)).

2. The hydrophobic inorganic particles according to claim 1,
wherein the organic compound is hydrophobic inorganic particles including carbon chains having 5 or more carbon atoms.

3. The hydrophobic inorganic particles according to claim 1,
wherein an average particle diameter d₅₀ is 0.1 μm to 100 μm.

4. The hydrophobic inorganic particles according to claim 1,
wherein the inorganic particles are hydrophobic inorganic particles composed of any one of silica, alumina, zinc oxide, boron nitride, aluminum nitride, and silicon nitride.

5. A resin composition for heat dissipation member comprising:
the hydrophobic inorganic particles according to claim 1; and
a resin.

6. The resin composition for heat dissipation member according to claim 5,
wherein the resin includes a thermosetting resin.

7. An electronic component device comprising:
the resin composition for heat dissipation member according to claim 5.
